(19) United States
(12) Patent Application Publication
(10) Pub. No.: US 2016/0326800 A1
(43) Pub. Date: Nov. 10, 2016

(54) Multiple curtain and roller blind

(71) Applicant: Norbert Marocco, Toronto (CA)

(72) Inventor: Norbert Marocco, Toronto (CA)

(21) Appl. No.: 14/999,358

(22) Filed: Apr. 28, 2016

Related U.S. Application Data
(60) Provisional application No. 62/179,411, filed on May 7, 2015.

(51) Int. Cl. E06B 9/42; A47H 1/04; A47H 13/04; E06B 9/58; A47H 15/04

(52) U.S. Cl. CPC E06B 9/42; E06B 9/58; A47H 15/04; A47H 13/04; A47H 1/04; E06B 2009/2452

(57) ABSTRACT

A combination window covering having; a head rail having at least a top wall, and a front wall; a roller blind support mechanism at each end of said top wall for supporting a roller blind thereon; a bottom wall extending rearwardly from said front wall; a first curtain I beam rail supported along the under side of said bottom wall, for attachment of a first curtain.

This application is based on U.S. Provisional application Ser. 62/179,411 Filed May 7 2015 title, Multiple Curtain and Roller Blind, inventor Norbert Marocco, the priority of which is claimed.

### FIELD OF THE INVENTION

The invention relates to a combination roller blind and curtain assembly in which a single blind head rail provides for support of both conventional curtains on the usual curtain gliders and rods, and also incorporates a black out roller blind.

### BACKGROUND OF THE INVENTION

The provision of curtains, supported on conventional curtain rods or I-beams has been well known for years. Such curtains are provided with gliders such as hooks which are generally z-shaped, or they have a plurality of prongs. The hooks connect with devices such as wheeled trolleys which run along the rods or I-beams. This enables the owner to be able to draw the curtains back, away from the window, or to close them. Curtains suspended from I-beams by wheel trolleys such as this have been known for a great many years. They function satisfactorily for the purpose intended.

However most home owners prefer to have some form of concealment for the I-beams and wheel trolleys. This concealment may take the form of a simple strip of fabric suspended from the ceiling, or a strip of wood or plastic, known as a valance. It has even been known to provide two sets of such I-beams each secured parallel to the other on the ceiling, on a common plane. Two separate sets of curtains may have been suspended, typically from wheeled trolleys, on the two sets of I-beams. In many cases the one curtain was simply a sheer curtain to provide privacy but to admit outside light and the other curtain was of fabric. However such sheers did not provide total privacy in the evening when the interior of the building was illuminated. For this reason, the second set of curtains described above may have been provided made of heavier fabric, and providing for complete privacy for the interior.

It is becoming well understood that the provision of complete light exclusion is desirable, in some circumstances.

This may be desirable from the viewpoint of excluding heat build up from sunlight or possible damage to furniture. In addition, however, the exclusion of light is now recognized as being an important factor in assisting in a good nights sleep.

The provision of these two distinct objectives can be a problem in a single window covering such as a usual curtain assembly.

One simple problem is that the ceilings in most buildings consist of relatively thin wall board. Fastenings secured directly into such wall board for holding the I-beams in place might become loosened over time, and might cause damage to the ceiling. For these reasons, L-shaped brackets were provided. One leg of the L could be secured to the wall, alongside a window, and the horizontal portion of the L could support one or in some cases, two I-beams.

The actual total weight of the fabric in these cases might be sufficient to dislodge the fastenings of such L-shaped brackets. In addition the use of multiple curtain rails was in many cases unsightly.

Notwithstanding all of these problems, it is clearly desirable to provide consumers with a head rail system in which, by hanging for example, sheer curtains on an I-beam, and by providing an opaque dark effect roller blind behind them, it is possible to provide a much greater variation in the appearance of a room, than was possible either with sheers alone or with the roller blind alone. The roller blind may make it possible to exclude light during the day so that a person can sleep better during the day. It will also have the effect of excluding outdoor lighting at night. The provision of a sheer curtain, for example, which can be drawn across the roller blind will provide a more domestic welcoming feel to the room, and substantially hide the roller blind.

In a further requirement, there are customers who like to dress up their windows with what are called tie-back drapes. These tie-backs may be full curtains, but in most cases were simply panels of drapery material, hanging on each side of the window opening, but not extending across the full width. Such drapes are suspended at the top on a transverse curtain rail, and the lower part of the drape is drawn back and looped with a decorative tie or cord of some kind. In many cases, customers requirements will incorporate a desire for a sheer curtain arrangement which can be drawn completely across the window, and a pair of tie-back drapes along either side of the window opening, which are usually tied back, in many cases, permanently, to provide a desired decorative effect.

In these cases the incorporation of a black-out roller blind behind the sheer is also highly advantageous for the reasons described above.

In order to provide these various different possibilities, and satisfy the requirements and decorative tastes of a variety of different customers, it is desirable to provide a window covering head rail assembly which can be adapted either to the roller blind and sheer combination, or with only minor variation to the roller blind and sheer and tie back. One additional problem in the provision of such a combination of curtains and roller blind is that most customers will expect a valance of some kind to extend down from the head rail and cover the various mechanical components. Another factor is that such a combination blind should permit the use of existing curtain supports such as wire hooks and wheeled trolleys. This will enable the customer to arrange for the manufacture of curtains, for example sheers, or tie-backs, of their own selected material and having a particular desired appearance.

### BRIEF SUMMARY OF THE INVENTION

With a view to providing a combination window covering which meets these various requirements, the invention comprises a window covering head rail having an enclosure with at least a top wall, and a front wall, and having a roller blind support mechanism at each end of said top wall for supporting a roller blind thereon, and having a bottom wall extending rearwardly from said front wall, and having a first curtain support along the under side of said bottom wall, for attachment of a first curtain rail.

Usefully the head rail will also incorporate an attachment for a second curtain support, spaced from said first curtain support, enabling the support of two separate curtain systems on the same head rail, in addition to supporting the roller blind.

In one advantageous feature, there is a roller blind guide incorporated towards the back of the head rail, guiding the roller blind as close as possible to the window opening, and clear of any curtain on the first curtain rail to exclude light.

Preferably this roller blind guide will be supported on the bottom wall of the head rail enclosure by a guide support which extends rearwardly from the front wall.

Advantageously the invention will further provide for an optional second curtain support, which may be a groove, extruded along the upper region of said front wall, and a semi front wall extension connectable to the second curtain support and overlying a portion of said front wall for carrying a second curtain rail thereto.

Preferably there will be a first curtain rail supported on the under side of said bottom wall.

The bottom wall will be supported by a substantially upward arcuate bracing panel fitting within attachments on the inside of the front wall.

Preferably there will be a second curtain rail supported on said semi front wall extension, whereby two separate sets of curtains can be supported on respective separate curtain rails.

Preferably, one modification will incorporate the provision of a panel and a valance support on the head rail, which may be releasably attached as required.

In order to provide for a greater versatility of the components, the head rail may be adapted simply to support the roller blind alone, if that is what will meet the requirements of the customer.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a plan view of a typical 3-way window dressing provided by the use of the invention, having three window treatments, shown in a first position;

FIG. 2 is a plan view of the window covering of FIG. 1 showing the various curtains and the roller blind in a different position;

FIG. 3 is a section along 3-3 of FIG. 2 showing the form of head rail incorporating a semi front wall extension for tie-back drapes;

FIG. 4 is a plan view of a typical simpler window covering provided by the use of the invention;

FIG. 5 is a plan view of the head rail of the window covering of FIG. 4 showing the sheers and roller blind in a position different from FIG. 4;

FIG. 6 is a section along the line 6-6 of FIG. 5;

FIG. 7 is a section along a simplified arrangement of the head rail for a simple roller blind;

FIG. 8 is a section of another embodiment valance;

FIG. 9 is a section of another embodiment, showing a one piece extrusion for the head rail with a three window covering capability;

FIG. 10 is a section of another embodiment, showing a one piece extrusion for the head rail with a two window covering capability, and,

FIG. 11 is a section of another embodiment, showing a one piece extrusion for the head rail with a two window covering capability, and showing a valance support formed as an integral extrusion in one piece with the head rail enclosure itself.

### DESCRIPTION OF A SPECIFIC EMBODIMENT

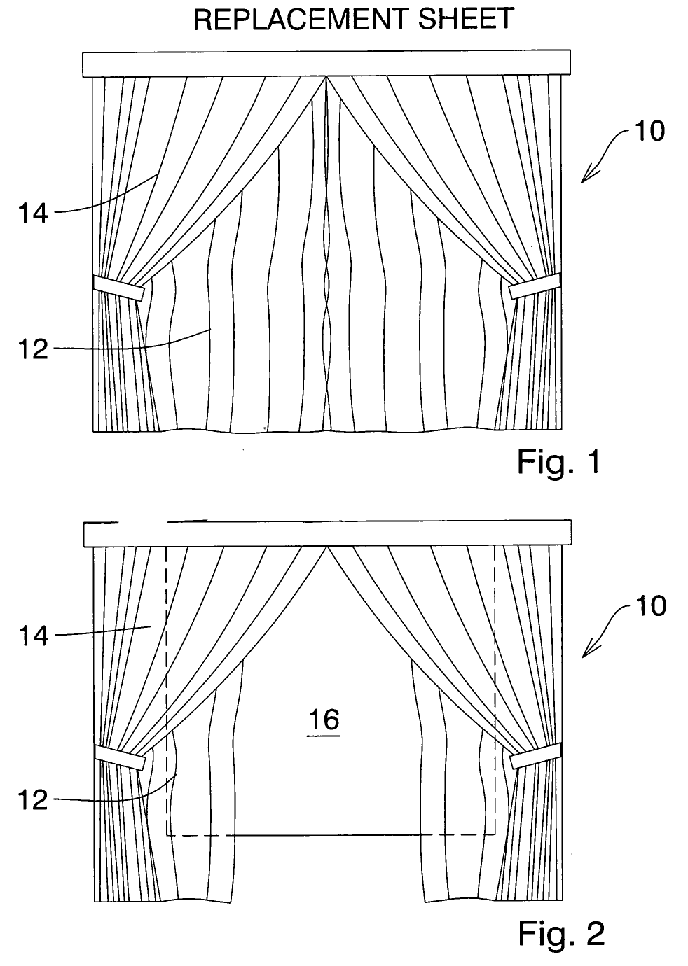

As illustrated generally in FIGS. 1 and 2, a typical window covering incorporating the head rail invention is shown as (10). This typical window covering in this case, comprises three separate covering treatments, namely, sheer (12), and tie back curtains or drapes (14) and a roller blackout blind (16) (FIG. 2).

FIG. 2 illustrates the various window coverings of FIG. 1, shown in a different arrangement. There is no specific limitation to these views since obviously the various window coverings can be arranged in any manner suitable to the customer at any given moment.

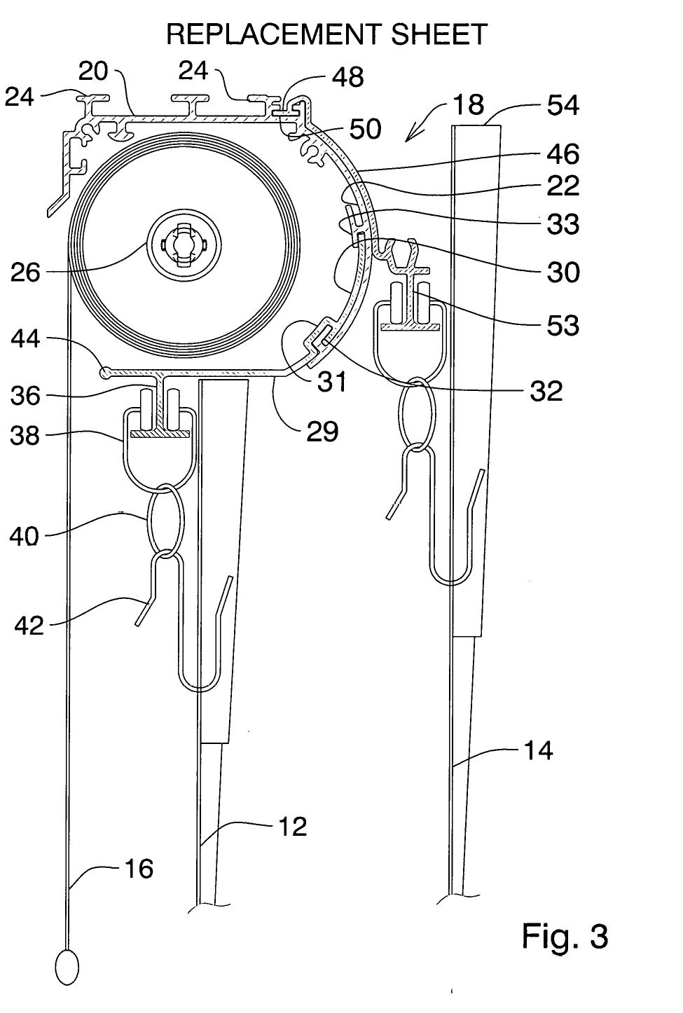

In order to provide this combination of window coverings in a single head rail, the window covering head rail is illustrated in more detail in FIG. 3.

It is seen that the head rail (18) has an enclosure consisting of a top wall (20) and a front wall (22). The top wall and front wall extend end to end and may typically be formed of a single extrusion of preferably aluminum metal. Suitable fastening formations indicated generally as (24) are used for securing either the top wall to the ceiling of the building, or suspending the head rail from some form of wall fastenings or brackets (not shown) adjacent to the window itself. The details of such fastenings and brackets are well known in the art and require no special description.

Within the head rail (18), at each end, there are roller blind supports (26). The roller blind supports (26) will have stub axles on which the roller blind can be mounted. In some cases it may be that the roller blind will comprise a continuous hollow member on which the roller blind itself is wound. In some cases it may be that all that the customer requires is a typical spring wound roller blind. Such a spring (not shown) is an elongated coil spring which fits within the roller blind, and a ratchet form of lock is located at one end. Such roller blinds can simply be pulled down by hand to a desired level, and can be released later by pulling on the blind to release the ratchet. Such spring operated roller blinds are very well known in the art and require no description. In this case, as illustrated, the roller blind is operated by means of an endless loop chain, operating a toothed wheel (not shown). Operation of the endless loop will cause the wheel to rotate one way or the other, thereby lowering or raising the roller blind. In order to support a first shade covering, in this case the sheer (12), a bottom wall (29) is formed which is generally planar. Bottom wall (29) is connected to the inside of front wall (22). This connection is in the form of a semi-arcuate upright bracing panel (30) which extends upwardly, and is formed integrally with the bottom wall (29). The bracing panel (30) is radiussed so as to fit snugly against the inside of the curved front wall (22). The panel (30) is attached to the front wall (22) by a lower groove (31). Groove (31) embraces an attachment (32) formed on the lower edge of the front wall (22). The panel (30) extends upwardly, and at its upper extremity, it has an attachment received in an L shaped channel (33) formed integrally with the inside of the front wall (22). It will be seen that the panel (30) extends, in intimate contact with the inside of the front wall (22) for approximately one half of the extent of the front wall (22), and thus provides a secure form of attachment. This is merely a convenient way of providing interchangeable components. It will be appreciated that bottom wall (29) could be extruded as an integral part of the entire head rail formed in one piece.

On the underside of bottom wall (29) there is formed by integral extrusion, an I-beam rail (36), in this case for the purpose of supporting a typical sheer curtain. A plurality of wheeled trolleys (38) will be located on the I-beam (36). Such wheeled trolleys are well known in the art. Usually they incorporate attachment rings (40). The sheer may be attached to such trolleys by means of Z-shaped hooks (42), or in other cases by means of three pronged hooks.

In either case this enables the sheer curtains to be drawn together to the centre of the window opening or drawn apart.

Preferably, at the rearward edge of the bottom wall (29), a guide rib (44) may be formed. The guide rib (44) functions to keep the roller blind (16) spaced rearwardly, and away from the sheer (12) hanging on the I-beam (36) and close to the window.

In order to support a second curtain, in this case the tie-back drapes (14), a semi-front wall extension (46) is provided. Extension (46) is of arcuate section, and has a T-shaped fastening member (48) at its upper edge. The front wall (22) has a connecting groove (50) extruded therein for receiving the T-shaped fastening (48). In this way the extension (46) may be attached over a portion of the front wall (22), and will extend downwardly.

A tie-back drape support, in this case I-beam (52), is integrally extruded with extension (46), in the embodiment. Typically the I-beam (52) is located in a plane somewhat above the sheer I-beam (36) carrying the sheers. The tie-back drapes (14) may be suspended from the I-beam (52) by any suitable means such as trolleys and wire hooks, or other forms of attachment.

Preferably the tie-back drapes (14) will have a pleated upper edge portion (54) which extends above the head rail and thus functions as a form of valance.

The tie-back drapes (14) can be simple window dressing panels, which are simply decorative, or they may be full curtains which could of course be drawn closed, if desired. They can also be drawn back further than is shown in the drawings.

In this way the one head rail (10) provides support for three separate window dressings namely the roller blind (16), the sheer panels (12), and the tie-back drapes (14).

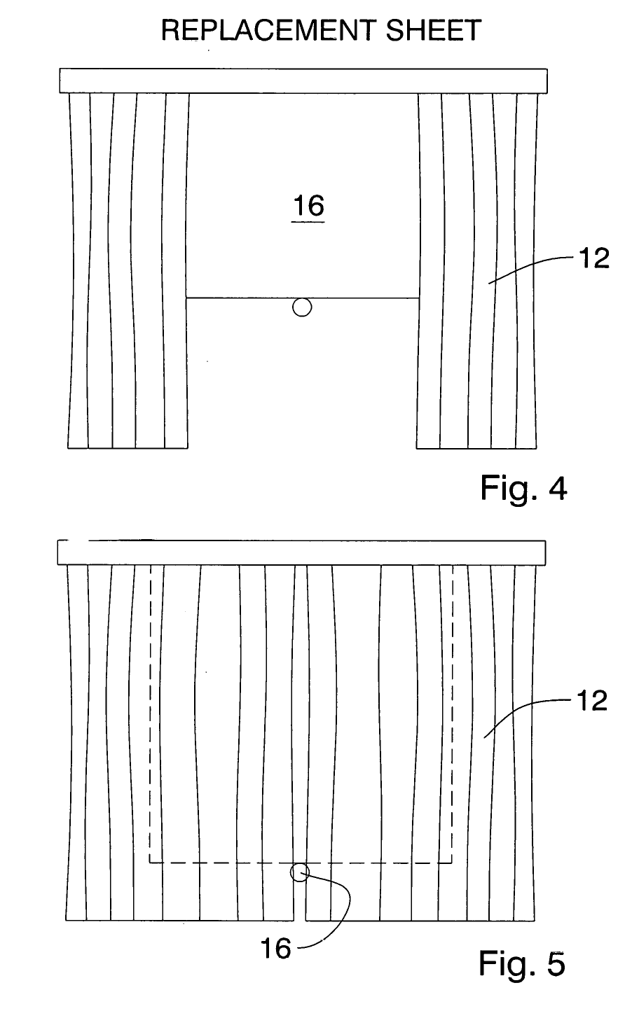

In many cases however, a simplified application may be all that is required. Possibly the customer does not require window dressings in the form of tie-back drapes. In this case, the appearance of the invention would be substantially as shown in FIGS. 4 and 5, showing the sheers (12), and the roller blind (16) in different positions simply by way of example.

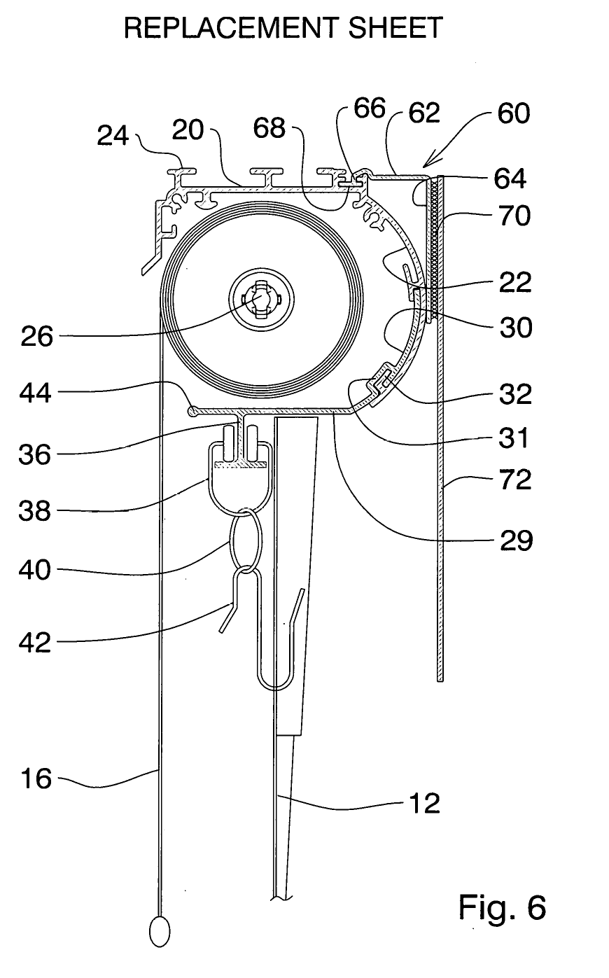

In this case, the semi-front wall extension has simply been omitted. The arrangement of the head rail appears in this case substantially as shown in FIG. 6. The same reference numbers are used in FIG. 6 as in FIG. 3 to denote the same parts.

In order to provide a customized appearance to the front of the head rail, a valance support bracket (60) may be provided. The bracket (60) in this case is typically a metallic extrusion, having a top wall (62) and a front wall (64) meeting in this case at 90 degrees. The top wall is provided with a T-shaped connector (66), which can be inter engaged with a groove (68) formed on the top wall of the head rail (10).

The bracket (60) will typically support some kind of fabric. In order to do this it may be provided with some form of simple attachment such as hook and pile fastening (70). In this way for example a strip of the curtain material (72) may be sewn to the appropriate dimensions and attached to the bracket (60). Other forms of decorative trim may be applied if desired.

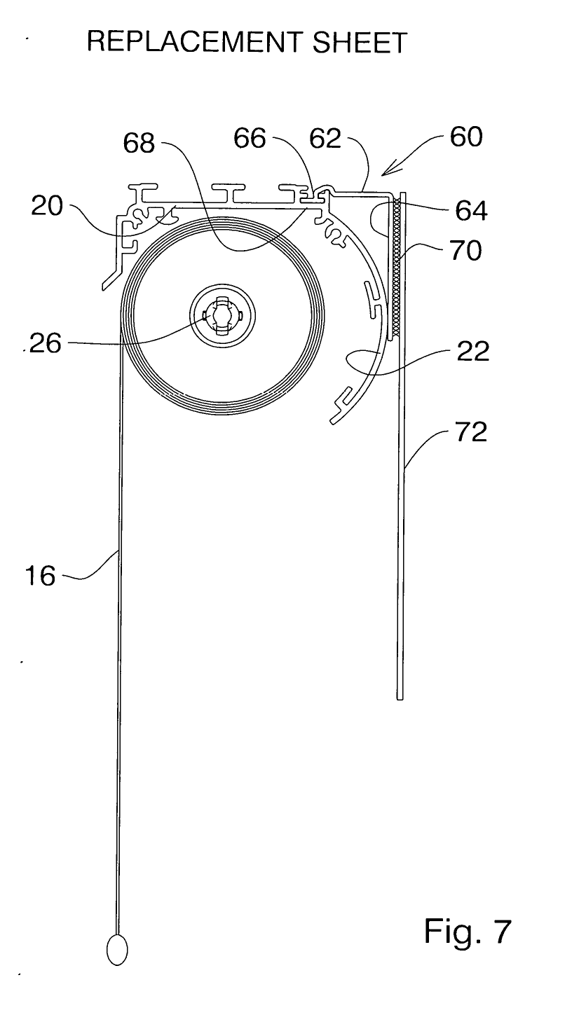

It is also possible that there may be some customers who simply want to install a roller blind by itself. In this case, all that is required is a further reduction in the head rail as shown in FIG. 7. In this case, the bottom wall has been left out. The head rail is otherwise the same as the head rail of FIG. 6. The head rail will support and conceal the roller blind as shown, and the customer can simply operate the roller blind by itself as required.

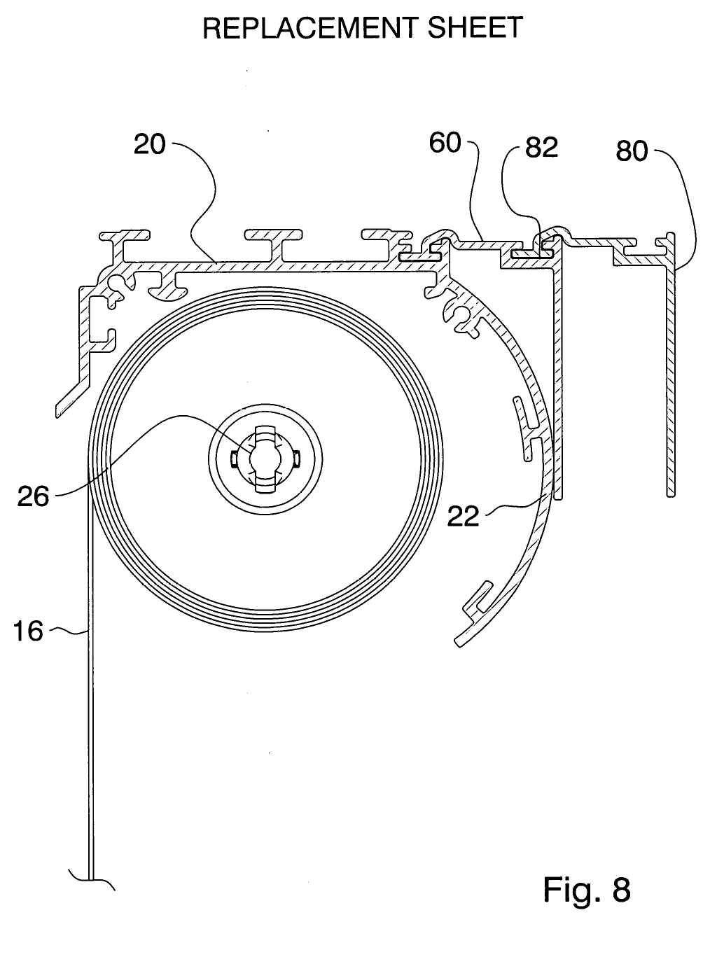

A further valance (80) (FIG. 8) may be useful in some cases. It can be attached to bracket (60) by T-lock (82). Bracket (60) attaches to the top wall (20) of the head rail as before.

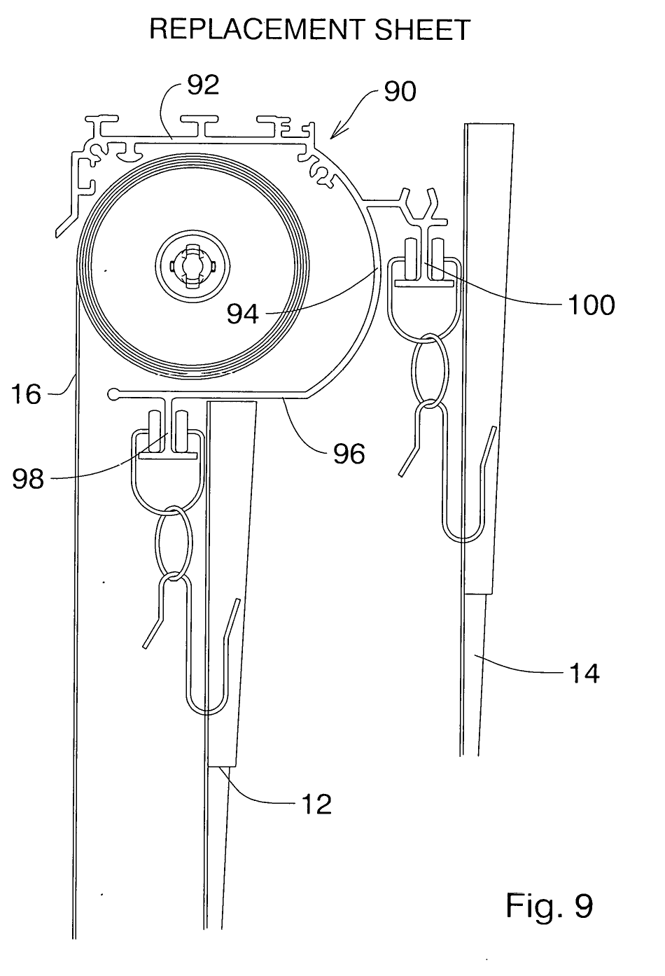

The head rail components namely the top wall (20), front wall (22) and even the bottom wall, and even the valance supports may all be made in a one piece integral extrusion as shown in FIGS. 9, 10 and 11.

FIG. 9 shows a one piece integral head rail enclosure (90) having top wall (92), a front wall (94), and a bottom wall (96) all formed as a single integral one piece extrusion.

The bottom wall has an integral I beam (98), and the front wall has an integral I beam (100). This arrangement provides support for a roller blind (16) a first window covering (12), and a tie back window dressing (14), all in a one piece integral head rail enclosure.

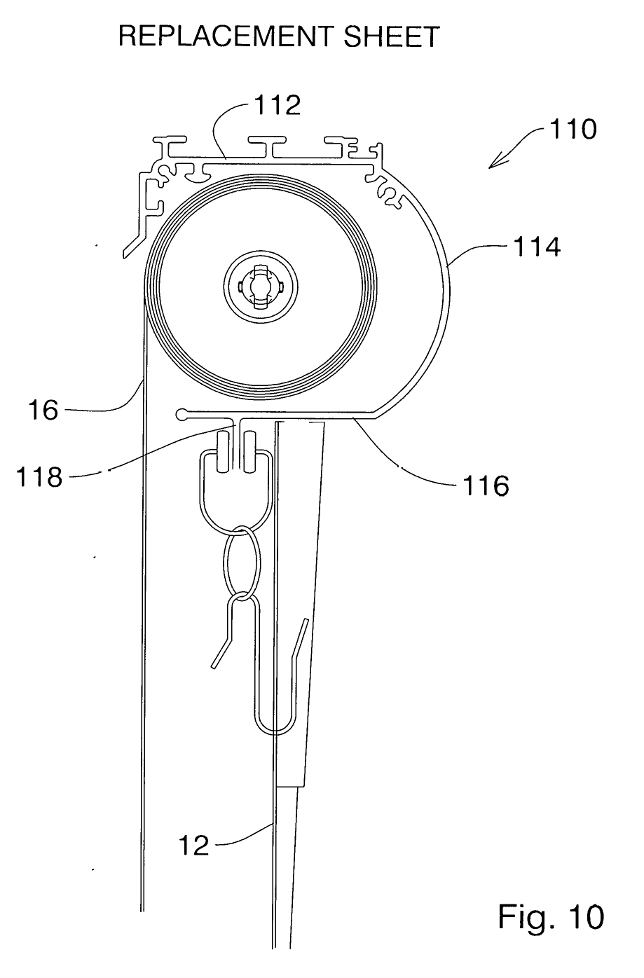

FIG. 10 shows a head rail enclosure (110) having top wall (112), a front wall (114) and a bottom wall (116) all formed in a single integral one piece extrusion.

Bottom wall (116) has an I beam (118) formed integrally, typically for a sheer window covering This arrangement will provide support for a roller blind and one window covering.

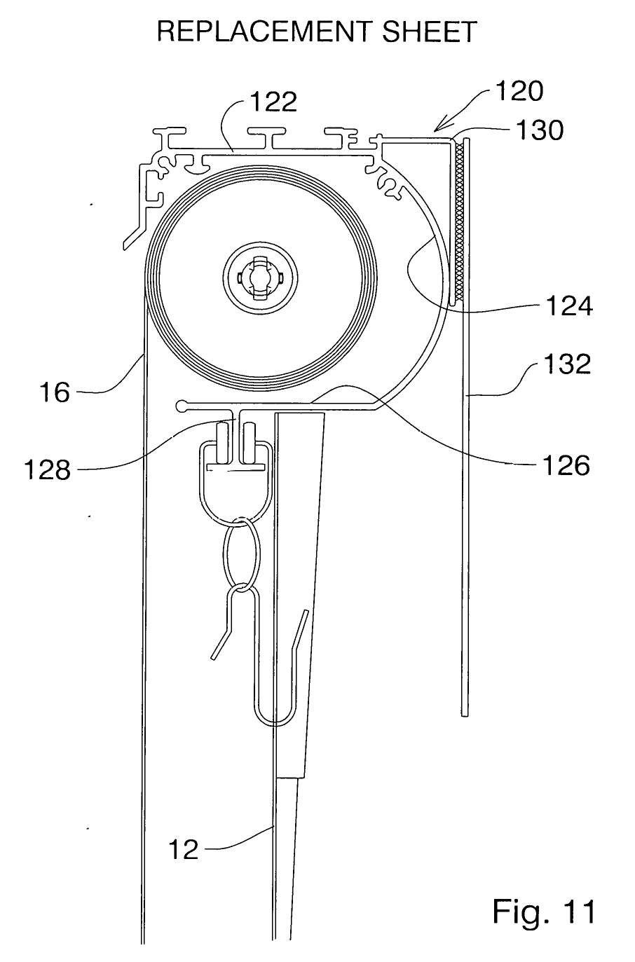

FIG. 11 shows a head rail enclosure (120) having top wall (122) a front wall (124) and a bottom wall (126), with an I beam (128), all formed as an integral one piece extrusion.

In addition an integral valance support (130) is also formed integrally with the head rail enclosure in one piece as an extrusion for supporting a valance material (132).

This version with minor modification may provide for supporting a roller blind and either one window covering as shown, or two window coverings and with the valance.

In all three versions the roller blind is shown in its usual place.

The foregoing is a description of a preferred embodiment of the invention which is given here by way of example only. The invention is not to be taken as limited to any of the specific features as described but comprehends all such variations thereof as come within the scope of the appended claims.

What is claimed is:

1. A combination window covering head rail comprising;
a head rail enclosure having at least a top wall, and a front wall extending end to end of said head rail;
a roller blind support mechanism at each end of said top wall for supporting a black out roller blind thereon;
a bottom wall extending rearwardly from said front wall, beneath and spaced below said top wall, and defining an underside; and,
a first curtain rail supported on said under side of said bottom wall, for attachment of a first curtain.

2. The combination window covering head rail as claimed in claim 1 and including a second curtain rail spaced from said first curtain rail for supporting a second curtain spaced from a first curtain enabling the support of said first curtain and of said second curtain, on the same head rail, as well as the black out roller blind.

3. The combination window covering head rail as claimed in claim 2 and including a roller blind guide incorporated towards the back of the head rail, guiding the roller blind close to the window opening to ensure exclusion of light, and controlling the roller blind clear of said first curtain on the first curtain rail.

4. The combination window covering head rail as claimed in claim 3 and wherein said bottom wall defines a forward edge attached to said front wall and a rearward edge extending rearwardly and said roller blind guide support being formed integrally with the bottom wall and extending along the rearward edge of said bottom wall.

5. The combination window covering head rail as claimed in claim 2 and including a second curtain rail support groove extruded along an upper region of said front wall, and a semi front wall extension connectable to said second curtain rail support groove and overlying a portion of said front wall.

6. The combination window covering head rail as claimed in claim 5 and including a second curtain rail supported on said semi front wall extension, whereby first and second window covering curtains can be supported on respective first and second curtain rails, in spaced apart relation.

7. The combination window covering head rail as claimed in claim 1 and including a valance support groove formed integrally on the head rail, and a valance member connected to said valance support groove on said head rail, by means of which a valance member may be releasably attached to said head rail.

8. The combination window covering head rail as claimed in claim 7 wherein said valance support groove comprises a pair of L-shaped formations on said top wall of said head rail defining said valance support groove, and wherein said valance member has a T-shaped retention member engaging with said valance support groove.

9. The combination window covering head rail as claimed in claim 8 including fabric retention means on said valance member for holding a panel of fabric thereon.

10. The combination window covering head rail as claimed in claim 9 wherein said valance member defines a horizontal portion and a generally vertical portion, said vertical portion being dimensioned to extend downwardly over said front wall and terminating in a lower edge tangential to said front wall.

11. The combination window covering head rail as claimed in claim 10 wherein said first and second curtain rails are I beams supporting wheeled trolleys on said I beams for carrying said curtains therefrom.

12. The combination window covering head rail as claimed in claim 11 wherein said top wall and said front wall and said bottom wall and said I beams are all formed as a single integral extrusion.

13. The combination window covering head rail as claimed in claim 12 wherein said valance member is formed as an integral part of said top wall and said front wall as a single integral extrusion.

14. The combination window covering head rail as claimed in claim 1 wherein said top wall is generally planar and horizontal, and said front wall defines a convex curvature having a front wall upper edge extending along said top wall, and defining a front wall lower edge.

15. The combination window covering head rail as claimed in claim 14 wherein said bottom wall is generally planar and horizontal, extending rearwardly from said front wall lower edge.
